(19) United States
(12) Patent Application Publication
(10) Pub. No.: US 2009/0116125 A1
(43) Pub. Date: May 7, 2009

(54) LENS SYSTEM

(75) Inventors: Aleksey Kolesnychenko, Eindhoven (NL); Sjoerd Stallinga, Eindhoven (NL); Hendrik Roelof Stapert, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/302,049

(22) PCT Filed: May 25, 2007
(86) PCT No.: PCT/IB07/51986

§ 371 Date: Nov. 24, 2008

(30) Foreign Application Priority Data
May 30, 2006 (EP) 06114668.4

(51) Int. Cl. G02B 9/00; G02B 17/00; G01J 5/08

(52) U.S. Cl. 359/735; 359/754; 374/130

(57) ABSTRACT

The present invention concerns a lens system. More specifically, it concerns a lens system comprising a first lens (3), a deflection element (5) and a second lens (6), wherein the deflection element (5) is arranged between the first lens (3) and the second lens (6). The deflection element comprises at least a first annular zone and a second annular zone, the annular zones being arranged in a concentric fashion and wherein the deflection angle of each annular zone is different from the deflection angle of every other annular zone. Furthermore, the present invention concerns a temperature analysis system comprising a lens system and the use of a temperature analysis system.

### BACKGROUND OF THE INVENTION

The present invention concerns a lens system. More specifically, it concerns a lens system comprising a first lens, a deflection element and a second lens, wherein the deflection element is arranged between the first lens and the second lens. Furthermore, the present invention concerns a temperature analysis system comprising a lens system and the use of a temperature analysis system.

Lab-on-chip or biosensors are very powerful tools for medical diagnostics, drug development, the chemical industry, etc. as they allow fast and integrated solutions using very small amounts of chemicals. Often, in order to obtain the diagnostic information the (final) analyze could be, for example, labeled by a fluorescent label. Upon illumination the label can absorb a photon and consequently emit a photon of different wavelength. This can be detected by an optical system.

Therefore the measurement of the concentration of a certain molecule in the sample solution, for example a blood sample, is related to the fluorescence intensity and the binding kinetics. For the binding kinetics (the processes that determine the number of binding events) the temperature, especially the temperature at the binding sites, is an important parameter. Accurate and local measurement of the temperature is the key for proper interpretation of the number of targeted molecules in the sample. It may be measured by imaging the area of the bioassay with an infrared camera. However, this requires expensive equipment like an IR CCD camera.

Numerous attempts have been undertaken in the art for determining or controlling the accurate local temperature in assay systems. US 2004/0180369 A1 discloses a nucleic acid hybridization assay, which is carried out at a solid surface. Capture probes comprising single-stranded oligonucleotides are immobilized to a solid substrate surface. In some embodiments using sandwich assay methods, the capture probes hybridize complementary target nucleic acid sequences, which in turn are bound to detection probes comprising nanoparticle-oligonucleotide conjugates comprising target-complementary oligonucleotides. In some embodiments, detection probes comprise nanoparticles attached to molecules comprising one partner of a ligand-binding pair (e.g., streptavidin), while target sequences comprise the other partner of the ligand-binding pair (e.g., biotin). The solid surface is exposed to light at a wavelength that is absorbed by the nanoparticle, thus eliciting a temperature jump. The heat generated by the nanoparticle is detected by a photothermography such as infrared thermography.

The art as taught in US 2004/0180369 A1 is disadvantageous in that reliance is placed upon the heating of nanoparticles. These may vary in size, composition and colloidal stability. Furthermore, this indirect approach adds another source for errors like systematic measurement errors. Lastly, this approach is limited to molecules undergoing strong interactions. Weak and reversible interactions between molecules cannot be studied.

US 2004/0184961 A1 discloses an apparatus and method for monitoring a large number of binding interactions and obtaining data related to the interactions. In accordance with the illustrative embodiment, the apparatus includes an IR sensor, a sliding separator, and IR-transmitting fibers that are optically coupled, at a first end thereof, to the sensor. The sliding separator adjusts the spacing between fibers as is required for interfacing the second end of the fibers with any variety of sample carriers. The second end of the fibers captures chemical entities from the sample carriers. The chemical entities at the end of the fibers are then contacted with a binding compound. If binding activity occurs, a thermal signal indicative thereof will be transmitted through the fiber to the sensor.

This is disadvantageous because the use of IR-transmitting fibers introduces a complexity into the design and additionally limits the number of probes that can reasonably be studied. Furthermore, the requirement of bonding chemical entities to the end of the fibers places a limit upon the number of possible chemical entities and thus the number of possible interactions, which can be studied. As the fibers need to be in contact with the probe solution, the use in infectious matrices like blood restricts them to a single use. This is very costly.

Despite these efforts there still exists a need in the art for simple components of thermal assay systems which are cheap to manufacture, not physically in contact with the probe solutions and which may be employed in a wide variety of applications.

### SUMMARY OF THE INVENTION

The present invention has the object of overcoming at least one of the drawbacks in the art. More specifically, it has the object of providing a system of components for thermal assay systems which is cheap to manufacture, whose main components are not in contact with the sample and which allows for a wide variety of thermal assay targets to be studied.

The present invention achieves this object by providing a lens system comprising a first lens, a deflection element and a second lens, wherein the deflection element is arranged between the first lens and the second lens, wherein the material constituting the first lens, the deflection element and the second lens has a refractive index for infrared light of ≧1.01 to ≦10 and that the deflection element comprises at least a first annular zone and a second annular zone, the annular zones being arranged in a concentric fashion and wherein the deflection angle of each annular zone is different from the deflection angle of every other annular zone.

With a lens system according to the present invention it becomes possible to focus the infrared light coming from an annular surface area onto a detector. Infrared light coming from a neighboring annular surface area, e.g., from a ring with a larger or smaller diameter, is focused onto an adjacent detector. Therefore, the signal arising from each detector can be assigned to a certain annular surface area. This setup can be achieved with very cheap individual components. Furthermore, it can be miniaturized easily.

An additional advantage of the present invention is that it is a passive system and does not rely on irradiation with electromagnetic radiation in order to elicit a response. This improves the accuracy and versatility of the system.

### BRIEF DESCRIPTION OF THE DRAWINGS

FIG. 1 shows a temperature analysis system comprising a lens system according to the present invention and further comprising a probe mount with probe wells and a detector array

FIG. 2 shows a temperature analysis system comprising a lens system according to the present invention, further comprising a probe well, a first detector array, a dichroid mirror, a third lens and a second detector array

FIG. 3 shows a probe well as used in the present invention

### DETAILED DESCRIPTION OF THE INVENTION

Before the invention is described in detail, it is to be understood that this invention is not limited to the particular component parts of the devices described or process steps of the methods described as such devices and methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise.

In the present invention, “first lens” and “second lens” refers to lenses, which may independently of each other have a planconvex, biconvex and/or convex-concave design. Their outer surfaces may independently have a spherical and/or aspherical curvature. The focal length of the first lens can be in a range of ≧0.1 cm to ≦10 cm, preferably from ≧0.5 cm to ≦5 cm and more preferred from ≧1 cm to ≦3 cm. Independently, the focal length of the second lens can be in a range of ≧0.1 cm to ≦10 cm, preferably from ≧0.5 cm to ≦5 cm and more preferred from ≧1 cm to ≦3 cm. In both cases the focal length is to be understood as the focal length for infrared light. The lenses can comprise, but are not limited to, materials selected from the group comprising calcium fluoride, sapphire, polyethylene, germanium, silicon and/or zinc sulphide.

The term “deflection element” refers to an optical element which is capable of bending parallel beams of light so that they are still parallel to each other but have a different angle to the optical axis than before the deflection element. The deflection element can comprise, but is not limited to, materials selected from the group comprising calcium fluoride, sapphire, polyethylene, germanium, silicon and/or zinc sulphide.

“Infrared light” refers to electromagnetic radiation having a wavelength of ≧800 nm to ≦15000 nm, or in other units of ≧0.8 μm to ≦15 μm. It is possible that the radiation is the black body radiation of an object.

The term “refractive index for infrared light” refers to the overall refractive index of the individual optical component. If, for example, the optical component is surface-treated so that the surface has a different refractive index than the bulk material, the overall refractive index is a result of the sum of these effects. In other words, the overall refractive index is the refractive index infrared light experiences when passing through the optical component.

In the present invention, the deflection element comprises at least a first annular zone and a second annular zone. The annular zones are arranged in a concentric fashion. In the event that the deflection element comprises only two annular zones, the inner zone can also have a circular form. What is to be understood by the term “deflection angle of an angular zone” is that mutually parallel beams of light, arriving at the annular zone of the deflection element, are deflected at an angle to the effect that while they are still mutually parallel, they are now at a different angle to the optical axis.

It is a feature of the present invention that the deflection angles of each annular zone of the deflection element differ from each other. For example, the deflection angle of the innermost annular zone may be the smallest of the arrangement, the deflection angle of the adjacent zone is larger, and so on. Alternatively, the deflection angle of the innermost annular zone may be the largest of the arrangement, the deflection angle of the adjacent zone is smaller, and so on. The deflection angles may differ from each other by a constant factor like 2, 3, 4 or the like. Alternatively, they may not differ from each other by a constant factor in order to fully comply with special construction requirements.

With a lens system according to the present invention the temperature arising from an annular area can be averaged and measured. The measurement is possible when infrared light from an annular area is collected and focused onto a specified detector. A ring section with a larger or smaller diameter is focused onto another detector.

A lens system according to the present invention allows for spatial resolution and does not need any moving parts to achieve this resolution. Therefore, the system can be kept cheap, small and durable. As the infrared light from a surface is collected, the necessity of contacting a potentially hazardous sample is also eliminated.

Because there is no need for contacting the sample area, non-planar surfaces can also be analyzed. This can be advantageous when studying living objects. Eyes or lymph nodes are examples of non-planar areas, which can be investigated.

In one embodiment of the present invention the material constituting the first lens, the deflection element and the second lens has a refractive index for infrared light of ≧1.1 to ≦8, preferred of ≧1.2 to ≦6, more preferred of ≧1.3 to ≦5. As refractive materials may show a dispersion, i.e. the variation of the refractive index with respect to the wavelength of the radiation, materials with these refractive indices for infrared light are well suited for application in the wavelength range from ≧3 μm to ≦14 μm or even from ≧8 μm to ≦10 μm. These wavelength ranges are interesting because they can represent the temperatures routinely encountered during physiological studies and drug discovery research. For example, an infrared wavelength of 9.5 μm corresponds to a maximum radiance for a temperature frequently found in the mammalian body.

In another embodiment of the present invention the deflection angle of the first annular zone is from ≧5° to ≦70°, preferred of ≧10° to ≦45°, more preferred of ≧15° to ≦30° and wherein the deflection angle of the second annular zone is from ≧5° to ≦70°, preferred of ≧10° to ≦45°, more preferred of ≧15° to ≦30°. Optical elements with deflection angles in these ranges are cheaply available and do not impose unwanted bulk into the lens assembly. Infrared light beams deflected at these angles may be readily focused by the second lens without undue optical aberration.

In another embodiment of the present invention the deflection element is selected from the group comprising prism ring, Fresnel lens and/or diffraction grating. These optical elements are readily available and can be tailored to the exact needs of the assembly. In the case of prism rings, the prism surfaces directly facing the infrared light beams have different angles with the optical axis for each individual annular zone in order to ensure that the deflection angle for each annular zone is different from the others. The same principle applies to a Fresnel lens with individually different annular zones. In the case of a diffraction grating, the pitch and the grating vector may vary with the position in the grating plane.

In another embodiment of the present invention the lens system further comprises a detector array. The detector array is located behind the second lens and for best operation within the focal plane of this lens. The array comprises a plurality of detectors. They may be arranged in a one-dimensional fashion such as a linear configuration or in a two-dimensional way. The individual detectors may be sized so that their largest dimension on the surface of the array is from ≧10 μm to ≦2000 μm. The spacing of the individual detectors in one dimension may be from ≧10 μm to ≦2000 μm. The detectors may be temperature detectors such as IR detectors or detectors for visible light.

The temperature detectors serve to generate an electrical signal, which is dependent upon the IR radiation received. By calibration of the detectors the temperature can be calculated. The temperature detectors may be microbolometers or based upon semiconductors like InSb, HgCdTe, PbSe or AlGaAs alloys. With respect to the wavelength, the detectors may be sensitive for radiation with a wavelength of ≧3 μm to ≦14 μm, preferably ≧8 μm to ≦10 μm. Detectors for visible light generate an electrical signal in response to irradiation with visible light. By this, the intensity of a fluorescence signal may be quantified.

The detector array may be combined with a filter for visible light before the detectors. This serves to block off unwanted stray radiation, which could lead to false signals.

It is also envisioned that the detector array comprises both temperature and visible light detectors. They can be arranged in such a way that both visible light and temperature detectors are addressed by the same annular surface area emitting the IR and visible light. Either they are in close vicinity or, taking into account the dispersion of the material for the optical components, spaced apart. In both alternatives the simultaneous measurement of the temperature and the fluorescence intensity of a sample becomes possible.

In another embodiment of the present invention the lens system further comprises a diaphragm with an aperture. The diaphragm is situated between the first lens and the deflection element. For best operation, the diaphragm is located in the focal plane of the first lens. The deflection element is then located in a plane with the distance of twice the focal length of the first lens. The diaphragm can block off unwanted background radiation which otherwise would enter the lens system and cause misleading temperature readings. The aperture in the diaphragm, which is centered around the optical axis of the lens system, serves to limit the overlap between neighboring portions of the area from which IR radiation is emitted. The aperture may have a diameter of ≧1 mm to ≦10 mm.

In another embodiment of the present invention the lens system further comprises a probe mount. The probe mount, which for best operation is located in the focal plane of the first lens and opposite of the other components of the system, comprises probe wells where individual assay probes are contained. In order to take full advantage of the optical design of the present invention, the probes are arranged in a concentric ring fashion. The zones may be individually brought to specified temperatures like water heating/cooling or Peltier heating/cooling. The probe mount may, for example, have a diameter of ≧1 mm to ≦50 mm, preferably ≧2 mm to ≦20 mm, more preferably ≧3 mm to ≦10 mm. The probe well can comprise individual depressions capable of holding samples. The depressions may have a diameter of ≧10 mm to ≦5 mm, preferably ≧0.2 mm to ≦2 mm, more preferably ≧0.3 mm to ≦1 mm.

In another embodiment of the present invention the lens system further comprises a dichroid mirror, a third lens and a second detector array. The dichroid mirror serves to discriminate between IR and visible light radiation. For example, the dichroid mirror may let IR light go through unreflected and reflect visible light. Alternatively, the dichroid mirror may reflect IR light and let visible light pass unchanged. When the dichroid mirror is tilted so that the light hits the surface at an angle of other than 90°, IR light and visible light may be conveniently separated. The light that is reflected then passes through an arrangement comprising a third lens and a second detector, which corresponds in principle to the arrangement already discussed for the second lens and the first detector.

The second detector may be sensitive to visible light or to IR light. The purpose is to complement the range of the first detector.

The focal length of the third lens can be in a range of ≧0.1 cm to ≦10 cm, preferably from ≧0.5 cm to ≦5 cm and more preferred from ≧1 cm to ≦3 cm. With respect to the design of the third lens, a planconvex, biconvex or convex-concave design is possible. By the arrangement of this embodiment it becomes possible to simultaneously monitor the temperature of a sample and its fluorescence.

Another aspect of the present invention is a temperature analysis system comprising a lens system according to the present invention. This temperature analysis system is capable of performing simultaneous temperature assays. For example, it can be part of a diagnostic device, such as a lab-on-chip system.

A further aspect of the present invention is the use of a temperature analysis system according to the present invention for the determination of temperature(s). For example, embodiments of the present invention which allow the simultaneous monitoring of IR and visible light (from fluorescence labeling) can be used to record a melting curve. This is based upon the reasoning that certain solid substances exhibit fluorescence, which decreases or vanishes upon melting. The exact curve showing the variation of fluorescence intensity with the temperature is characteristic of each substance. Therefore, the use of an analysis system according to the present embodiment allows for an easy and fast way to establish the identity or non-identity of two substances without having to resort to more complicated instrumental analyses.

It is also possible to determine binding events in a sample if these events occur with a change in temperature of the system.

In addition to the determination of temperatures, the temperature analysis system according to the present invention may also be a part of a feedback loop. The feedback loop then includes a heating and/or a cooling device. This is important when the temperature of a sample has to be kept constant or when a well-defined temperature ramp is desired.

The present invention will become more readily understood when taking into account the figures as described in more detail below.

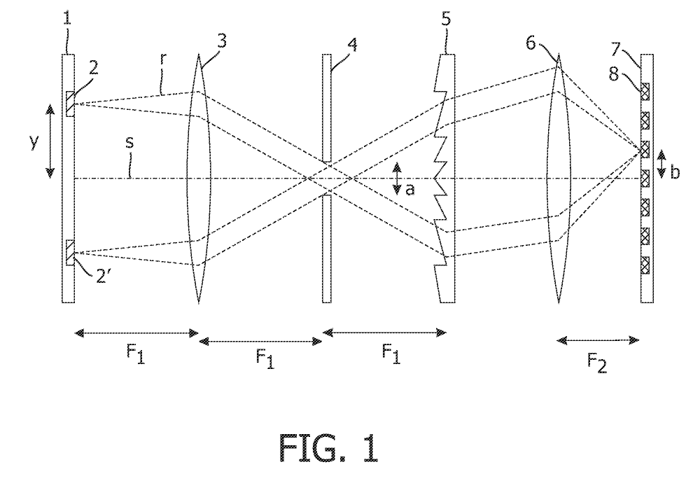

FIG. 1 shows a temperature analysis system according to the present invention. The view is to be understood as being from above the system. A probe mount (1) comprises probe wells (2) arranged in a concentric fashion around the optical axis (s). The surfaces of the probe wells constitute the optical object plane. This plane is subdivided into individual concentric zones. For each zone the temperature can be measured by detecting the emitted IR radiation. In one of these zones, the emitting points (2) and (2′) are at a distance (y) from the optical axis (s) of the system. Additional emitters on the ring with the radius (y) are present but not drawn.

These points emit IR beams (r), which are focused by the first lens (3) into parallel beams. The parallel beams then are at an angle γ/F₁ with the optical axis (s), where (F₁) is the focal length of first lens (3). The beams are incident on a diaphragm (4) with a circular hole of radius (a). Diaphragm (4) is located at the focal plane of first lens (3). The beams then pass further onto a tilted prism ring (5), which serves as the deflecting element. The function of this component is to bend the parallel beams of IR light, which are incident on the component at different angles into parallel beams that are mutually parallel. Graphically speaking, the beams before the tilted prism ring (5) form the surface of a cone and after the tilted prism ring (5) the surface of a cylinder. The common direction of propagation of these beams forms a certain angle β with the optical axis (s).

The tilted prism ring (5) as depicted in FIG. 1 shows a saw-tooth profile in cross-section. For a non-tilted prism ring, the angle of each “tooth” determines the angle over which the incoming parallel beam is bent. If this angle is chosen correctly all exiting beams are mutually parallel and parallel to the optical axis. When such a ring is tilted the exiting beams are still parallel but now form a certain angle with the optical axis.

A second lens (6) then focuses all these beams into a single point at the plane formed by the surface of detector array (7). The distance (b) of this point from the optical axis is given by the relationship b=βF₂, with (F₂) being the focal length of second lens (6). This point is on one of the detectors (8) of the detector array (7). Adjacent rings with the radius y+Δy within the same object zone are imaged onto the nearby point b+Δb. The size of detector array (7) is large enough to collect IR light from all rings within the object zone of probe mount (1).

Furthermore, the ring width of tilted prism ring (5) is sufficiently large to bend all light coming from the object zone at essentially the same angle.

Light originating from a different object zone is incident of a different ring area of the tilted prism ring. This different ring area also bends all incoming parallel beams in such a way that they are mutually parallel, but now at a common angle β′ from the optical axis. The image point is then at a distance b′=β′F₂ from the optical axis and is on a different detector (8) of the detector array (7).

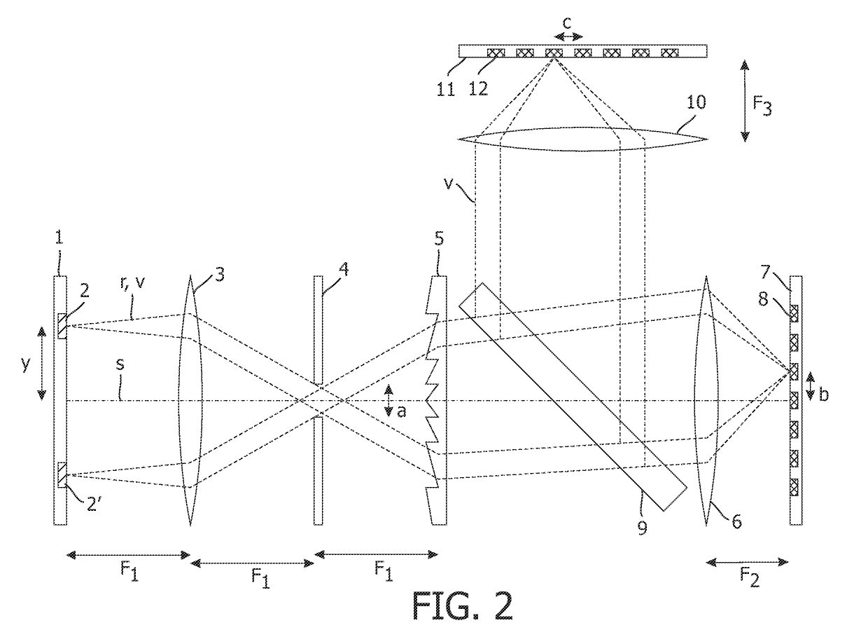

FIG. 2 shows a further temperature analysis system according to the present invention. The system corresponds to the system, which has been depicted in FIG. 1 and additionally comprises a dichroid mirror (9), a third lens (10) and a second detector array with individual detectors (11). Emitting points (2) and (2′) emit IR (r) and visible light (v). The visible light (r′) can originate from a fluorescence of a sample. The beams are focused by first lens (3), pass through diaphragm (4) and are deflected by deflection element (5).

What is now different from FIG. 1 is that dichroid mirror (9) separates the beams of IR light (r) and visible light (v). The infrared beam (r) passes through dichroid mirror (9) unaltered and is focused by second lens (6) onto detector (8) of detector array (7) as described above. The visible beam (v) changes its orientation through the action of the dichroid mirror (9). The individual beams of the visible beam are still parallel to each other. They are then focused by a third lens (10) onto a detector (12) of a second detector array (11). On detector array (11), the individual detectors (12) are spaced from each other with a distance of (c). The detector array (11) is located in the focal plane of third lens (10), as indicated by its focal length (F₃).

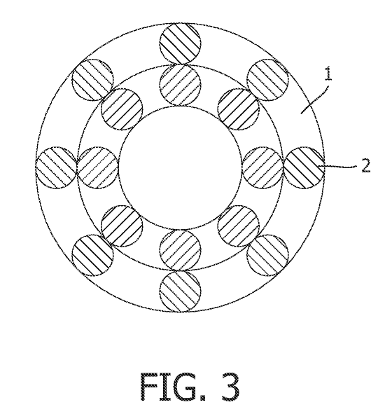

FIG. 3 shows a frontal view of probe mount (1) with circular probe wells (2) lying on concentric rings.

To provide a comprehensive disclosure without unduly lengthening the specification, the applicant hereby incorporates by reference each of the patent applications referenced above.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Reference signs used in the description and claims do not limit the scope of the invention as claimed.

1. Lens system comprising a first lens (3), a deflection element (5) and a second lens (6), wherein the deflection element (5) is arranged between the first lens (3) and the second lens (6), characterized in that
the material constituting the first lens (3), the deflection element (5) and the second lens (6) has a refractive index for infrared light of ≧1.01 to ≦10 and that the deflection element (5) comprises at least a first annular zone and a second annular zone, the annular zones being arranged in a concentric fashion and wherein the deflection angle of each annular zone is different from the deflection angle of every other annular zone.

2. Lens system according to claim 1, wherein the material constituting the first lens (3), the deflection element (5) and the second lens (6) has a refractive index for infrared light of ≧1.1 to ≦8, preferred of ≧1.2 to ≦6, more preferred of ≧1.3 to ≦5.

3. Lens system according to claim 1, wherein the deflection angle of the first annular zone is from ≧5° to ≦70°, preferred of ≧10° to ≦45°, more preferred of ≧15° to ≦30° and wherein the deflection angle of the second annular zone is from ≧5° to ≦70°, preferred of ≧10° to ≦45°, more preferred of ≧15° to ≦30°.

4. Lens system according to claim 1, wherein the deflection element (5) is selected from the group comprising prism ring, Fresnel lens and/or diffraction grating.

5. Lens system according to claim 1, further comprising a detector array (7).

6. Lens system according to claim 1, further comprising a diaphragm (4) with an aperture.

7. Lens system according to claim 1, further comprising a probe mount (1).

8. Lens system according to claim 1, further comprising a dichroid mirror (9), a third lens (10) and a second detector array (11).

9. Temperature analysis system comprising a lens system according to claim 1.

10. Use of a temperature analysis system according to claim 9 for the determination of temperature or temperatures.

11. Diagnostic device comprising a temperature analysis system according to claim 9.

12. Use of a diagnostic device according to claim 11 for determination of a melting curve.
